(19) United States
(12) Patent Application Publication
(10) Pub. No.: US 2022/0139066 A1
(43) Pub. Date: May 5, 2022

(54) Scene-Driven Lighting Control for Gaming Systems

(71) Applicant: Hewlett-Packard Development Company, L.P., Spring, TX (US)

(72) Inventors: Zijiang Yang, Shanghai (CN); Chuang Gan, Shanghai (CN); Aiqiang Fu, Shanghai (CN); Sheng Cao, Shanghai (CN); Yu Xu, Shanghai (CN)

(73) Assignee: Hewlett-Packard Development Company, L.P., Spring, TX (US)

(21) Appl. No.: 17/417,602

(22) PCT Filed: Jul. 12, 2019
(86) PCT No.: PCT/US2019/041505

§ 371 Date: Jun. 23, 2021

(51) Int. Cl. G06V 10/46; G06V 10/82; G06N 3/04; G06N 3/08

(52) U.S. Cl. CPC G06V 10/469; G06N 3/08; G06N 3/0454; G06V 10/82

(57) ABSTRACT

In one example, an electronic device may include a capturing unit to capture video content and audio content of an application being executed on the electronic device, an analyzing unit to analyze the video content and the audio content to generate a plurality of synthetic feature vectors, a processing unit to process the plurality of synthetic feature vectors to determine a content event corresponding to a scene displayed on the electronic device, and a controller to select an ambient effect profile corresponding to the content event and control a device according to the ambient effect profile to render an ambient effect in relation to the scene.

### BACKGROUND

Television programs, movies, and video games may provide visual stimulation from an electronic device screen display and audio stimulation from the speakers connected to the electronic device. A recent development in display technology may include adding of ambient light effects using an ambient light illumination system to enhance visual experience when watching content displayed on the electronic device. Such ambient light effects may illuminate surroundings of the electronic device, such as a television, a monitor, or any other electronic display, with light associated with the content of the image currently displayed on the electronic device. For example, some video gaming devices may cause lighting devices such as light emitting diodes (LEDs) to generate an ambient light effect during game play.

### BRIEF DESCRIPTION OF THE DRAWINGS

Examples are described in the following detailed description and in reference to the drawings, in which:

FIG. 1A is a block diagram of an example electronic device, including a controller to control a device to render an ambient effect in relation to a scene;

FIG. 18 is a block diagram of the example electronic device of FIG. 1A, depicting additional features;

FIG. 2A is a block diagram of an example cloud-based server, including a content event detection unit to determine and transmit a content event corresponding to a scene displayed on an electronic device;

FIG. 2B is a block diagram of the example cloud-based server of FIG. 2A, depicting additional features;

FIG. 3 is a schematic diagram of an example neural network architecture, depicting a convolutional neural network and a recurrent neural network for determining a type of action or content event; and

FIG. 4 is a block diagram of an example electronic device including a non-transitory machine-readable storage medium, storing instructions to control a device to render an ambient effect in relation to a scene;

### DETAILED DESCRIPTION

Vivid lighting effects that react with scenes (e.g., game scenes) may provide an immersive user experience (e.g., gaming experience). This ambient light effects may illuminate surroundings of an electronic device, such as a television, a monitor, or any other electronic display, with light associated with the content of the image currently displayed on a screen of the electronic device. For example, the ambient light effects may be generated using an ambient light system which can be part of the electronic device. For example, an illumination system may illuminate a wall behind the electronic device with light associated with the content of the image. Alternatively, the electronic device may be connected to a remotely located illumination system for remotely generating the light associated with the content of the image. When the electronic device displays a sequence of images, for example, a sequence of video frames being part of video content, the content of the images shown in the sequence may change over time which also results in the light associated with the sequence of images to change over time.

In other examples, lighting effects have been applied in gaming devices including personal computer chassis, keyboard, mouse, indoor lightings, and the like. In order to get an immersive experience, the lighting effects may have to respond to live game scenes and events in real time. Example ways to enable the lighting effects may include providing lighting control software development kits (SDKs) and may involve game developers to call application programming interfaces (APIs) in the game programs to change the lighting effects according to the changing game scenes on the screen.

Implementing the scene-driven lighting control using such methods may involve game developers to explicitly invoke the lighting control API in the game program. The limitations of such methods may include:

1. Lighting control may involve extra development effort, which may not be acceptable for the game developers.

2. Due to different APIs provided by different hardware vendors, the lighting control applications developed for one hardware manufacturer may not be supported on hardware produced by another hardware manufacturer.

3) Without code refactoring, a significant number of off-the-shelf games may not be supported by such methods.

In some other examples, gaming equipment venders may provide lighting profiles or user configurable controls, through which users can enable pre-defined lighting effects. However, such pre-defined lighting effects may not react with game scenes and thereby effects visual experience. One approach to match the lighting effects to the game scene in real-time is to sample the screen display and blend the sampled results into RGB values for controlling peripherals and room lighting. However, such approach may not have a semantic understanding of the image, and hence some different scenes can have similar lighting effects. In such scenarios, effects such as “flashing the custom warning light red when the game character is being attacked” may not be achieved.

Therefore, the lighting devices may have to generate the ambient light effects at appropriate times when an associated scene is displayed. Further, the lighting devices may have to generate a variety of ambient light effects to appropriately match a variety of scenes and action sequences in a movie or a video game. Furthermore, an ambient light effect-capable system may have to identify scenes, during the display, for which the ambient light effect has to be generated.

Examples described herein may utilize the audio content and video content (e.g., visual data) to determine a content event, a type of scene, or action. In one example, video stream and audio stream of a game may be captured during the game play and the video stream and the audio stream may be analyzed using the neural networks to determine a content event corresponding to a scene being displayed on the display. In this example, the video content may be analyzed using a convolutional neural network to generate a plurality of video feature vectors. The audio content may be analyzed using a speech recognition neural network to generate a plurality of audio feature vectors. Further, the video feature vectors may be concatenated with a corresponding one of the audio feature vectors to generate a plurality of synthetic feature vectors. Then, the plurality of synthetic feature vectors may be processed using a recurrent neural network to determine the content event. A controller (e.g., a lighting driver) may utilize the content event to select an ambient effect profile (e.g., a lighting profile) and set an ambient effect (e.g., a lighting effect) accordingly.

Thus, examples described herein may provide an enhanced content event, a type of scene, or action detection using the fused audio-visual content. By using audio and video content in combination, the neural network can achieve an enhanced scene, action, or content event prediction accuracy than using video content. Further, examples described herein may enable to control lighting effects transparent to game developers through the fused audio-visual neural network that understands the live game scenes in real-time and controls the lighting devices accordingly. Thus, examples described herein may enable real-time scene-driven ambient effect control (e.g., lighting control) without any involvement from game developers to invoke the lighting control application programming interface (API) in the gaming program, thereby eliminating business dependencies on third-party game providers.

Furthermore, examples described herein may be independent of hardware platform and can support different gaming equipment. For example, the scene-driven lighting control may be used in a wider range of games, including the games that may be already in the market and may not have considered lighting effects (i.e., may not have effects script embedded in the gaming program). Also, by training a specific neural network for each game, examples described herein may support the lighting effects control of off-the-shelf games without refactoring the gaming program.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

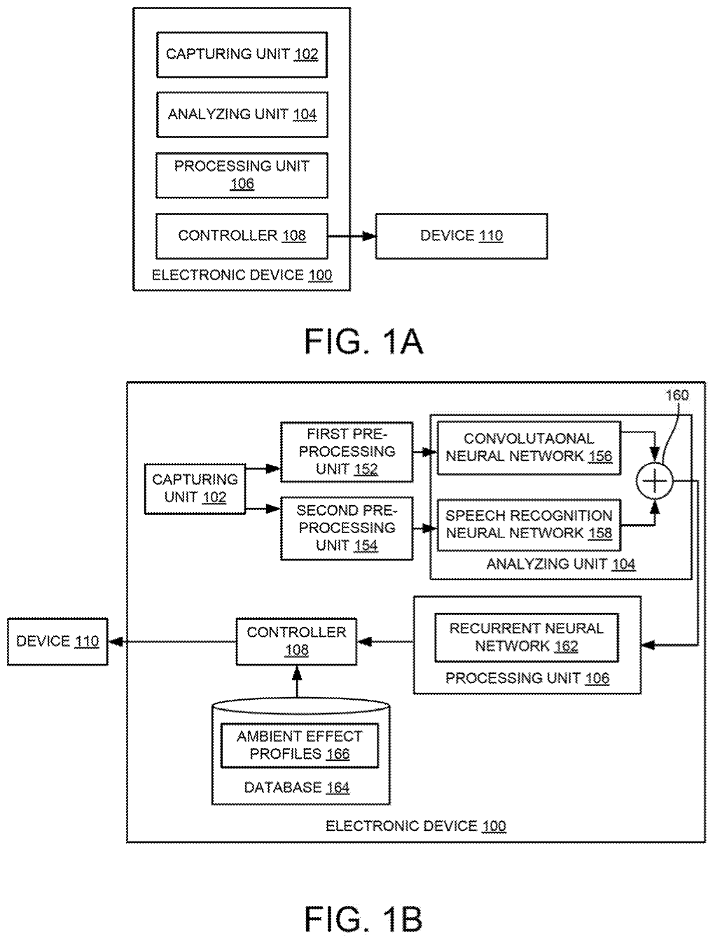

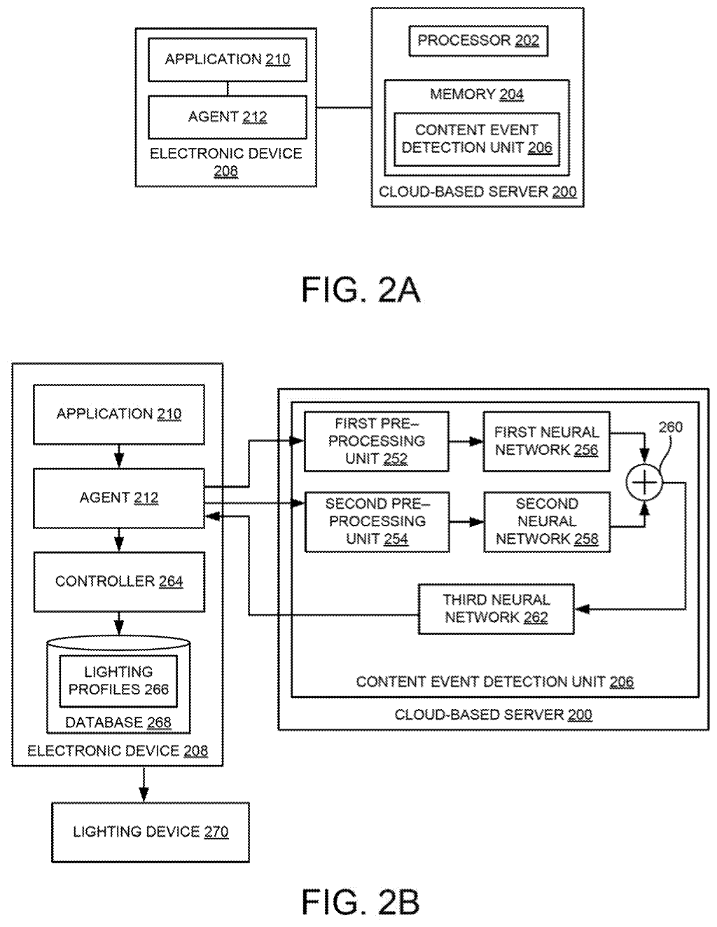

Turning now to the figures, FIG. 1A is a block diagram of an example electronic device 100, including a controller 108 to control a device 110 to render an ambient effect in relation to a scene. As used herein, the term “electronic device” may represent, but is not limited to, a gaming device, a personal computer (PC), a server, a notebook, a tablet, a monitor, a phone, a personal digital assistant, a kiosk, a television, a display, or any media-PC that may enable computing, gaming, and/or home theatre applications.

Electronic device 100 may include a capturing unit 102, an analyzing unit 104, a processing unit 106, and controller 108 that are communicatively coupled with each other. Example controller 108 may be a device driver. In some examples, the components of electronic device 100 may be implemented in hardware, machine-readable instructions, or a combination thereof. In one example, capturing unit 102, analyzing unit 104, processing unit 106, and controller 108 may be implemented as engines or modules comprising any combination of hardware and programming to implement the functionalities described herein.

During operation, capturing unit 102 may capture video content and audio content of an application being executed on the electronic device. Further, analyzing unit 104 may analyze the video content and the audio content to generate a plurality of synthetic feature vectors. Synthetic feature vectors may be individual spatiotemporal feature vectors corresponding to the individual video frames and audio segments that may characterize a prediction of a video frame or scene following individual video frames within a duration.

Furthermore, processing unit 106 may process the plurality of synthetic feature vectors to determine a content event corresponding to a scene displayed on electronic device 100. The content event may represent a media content state which persists (for example, a red damage mark indicating the character being attacked) in relation to a temporally limited content event. Example event may include an explosion, a gunshot, a fire, a crash between vehicles, a crash between a vehicle and another object (e.g. it surroundings), presence of an enemy, a player taking damage, a player increasing in health, a player inflicting damage, a player losing points, a player gaining points, a player reaching a finish line, a player completing a task, a player completing a level, a player completing a stage within a level, a player achieving a high score, and the like.

Further, controller 108 may select an ambient effect profile corresponding to the content event and control device 110 according to the ambient effect profile to render an ambient effect in relation to the scene. Example device 110 may be a lighting device. The lighting device may be any type of household or commercial device capable of producing visible light. For example, the lighting device may be stand-alone lamp, track light, recessed light, wall-mounted light, or the like. In one approach, the lighting device may be capable of generating light having color based on the RGB model or any other visible colored light in addition to white light. In another approach, the lighting device may also be adapted to be dimmed. The lighting device may be directly connected to electronic device 100 or indirectly connected to electronic device 100 via a home automation system.

Electronic device 100 of FIG. 1A may be depicted as being connected to one device 110 by way of example only, and that electronic device 100 can be connected to a set of devices that together contribute to make up the ambient environment. In this example, controller 108 may control the set of devices, each device being arranged to provide an ambient effect. The devices may be interconnected by either a wireless network or a wired network such as a powerline carrier network. The devices may be an electronic or may be purely mechanical. In some other examples, device 110 may be an active furniture fitted with rumblers, vibrators, and/or shakers.

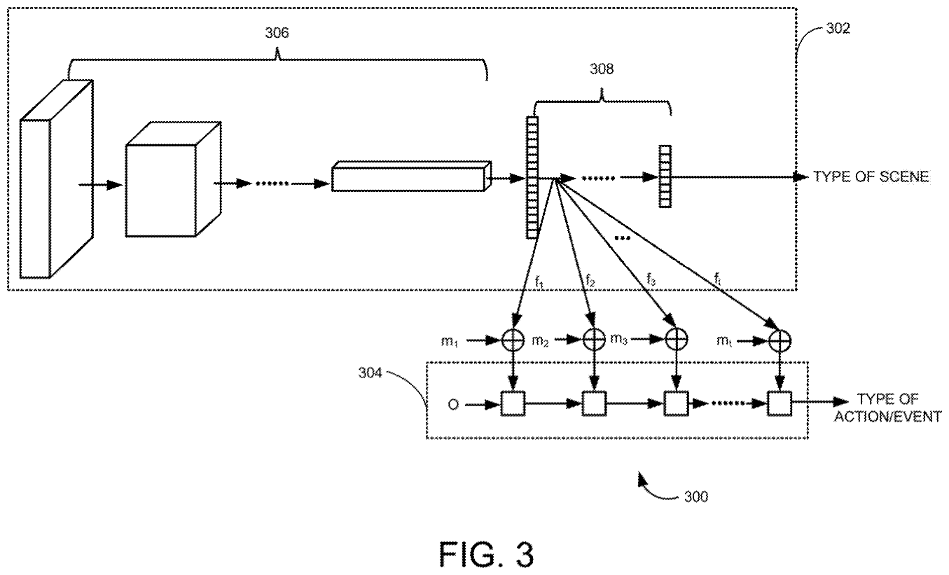

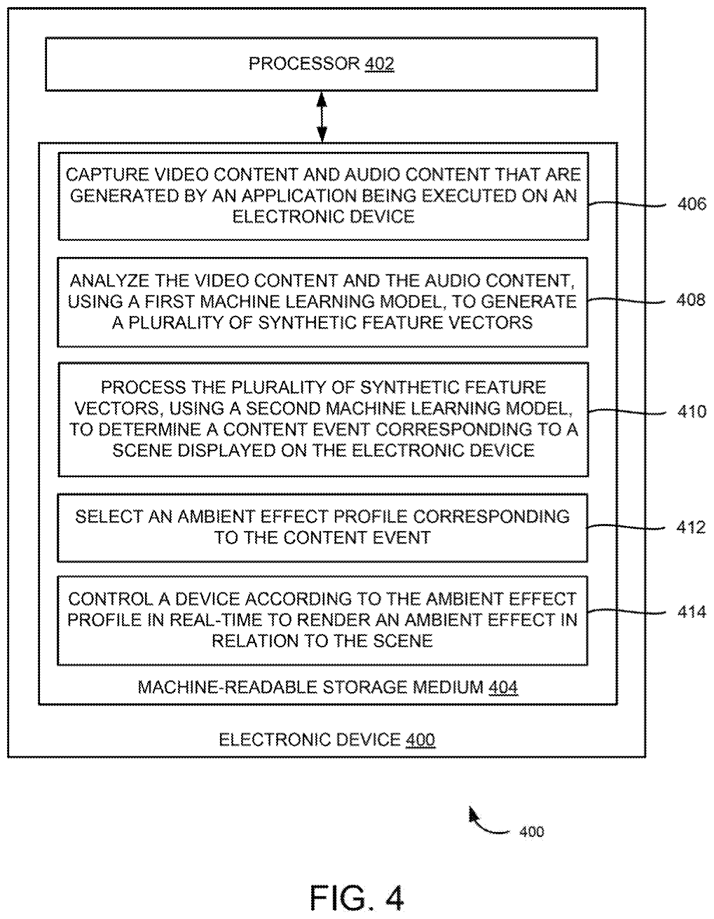

FIG. 1B is a block diagram of example electronic device 100 of FIG. 1A, depicting additional features. For example, similarly named elements of FIG. 1B may be similar in structure and/or function to elements described with respect to FIG. 1A. As shown in FIG. 18, capturing unit 102 may capture the video content (e.g., a video stream) and the audio content (e.g., an audio stream) generated by the application of a computer game during a game play. For example, capturing unit 102 may capture the video content and the audio content from a gaming application being executed in electronic device 100 or receive video content and the audio content from a video source (e.g., a video game disc, a hard drive, or a digital media server capable of streaming video content to electronic device 100) via a connection. In this example, capturing unit 102 may cause the video content (e.g., screen images) to be captured before display in a memory buffer of electronic device 100 using, for instance, video frame buffer interception techniques.

Further, the video content and the audio content may have to be pre-processed due to requirements of neural networks for the input data. Therefore, electronic device 100 may include a first pre-processing unit 152 to receive the video content from capturing unit 102 and pre-process the video content prior to analyzing the video content. For example, in the video pre-processing stage, each frame of the video stream can be adjusted to a substantially similar aspect ratio, scaled to a substantially similar resolution, and then normalized to generate the pre-processed video content.

Furthermore, electronic device 100 may include a second pre-processing unit 154 to receive the audio content from capturing unit 102 and pre-process the audio content prior to analyzing the audio content. For example, in the audio pre-processing stage, the audio stream may be divided into partially overlapping segments/fragments by time and then converted into a frequency domain presentation, for instance, by fast fourier transform.

The pre-processed video and audio content may be fed to neural networks to determine a type of game scene and action or content event that is going to occur. The output of the neural networks may be used by controller 108 (e.g., a lighting driver) to select a corresponding ambient effect profile (e.g., a lighting profile) and set the ambient effect (e.g., a lighting effect) accordingly.

In one example, analyzing unit 104 may receive the pre-processed video content and the pre-processed audio content from first pre-processing unit 152 and second pre-processing unit 154, respectively. Further, analyzing unit 104 may analyze the video content using a convolutional neural network 156 to generate a plurality of video feature vectors. Each video feature vector may correspond to a video frame of the video content. Furthermore, analyzing unit 104 may analyze the audio content using a speech recognition neural network 158 to generate a plurality of audio feature vectors. Each audio feature vector may correspond to an audio segment of the audio content. Further, analyzing unit 104 may concatenate the video feature vectors with a corresponding one of the audio feature vectors, for instance via an adder or merger 160, to generate the plurality of synthetic feature vectors. The synthetic feature vectors may indicate a type of scene being display on electronic device 100.

Further, processing unit 106 may receive the plurality of synthetic feature vectors from analyzing unit 104 and process the plurality of synthetic feature vectors by applying a recurrent neural network 162 to determine the content event. Furthermore, controller 108 may receive an output of recurrent neural network 162 and select an ambient effect profile corresponding to the content event from a plurality of ambient effect profiles 166 stored in a database 164. Then, controller 108 may control device 110 according to the ambient effect profile to render an ambient effect in relation to the scene. For example, device 110 making up the ambient environment may be arranged to receive the ambient effect profile in the form of instructions. Examples described herein can also be implemented in a cloud-based server as shown in FIGS. 2A and 2B.

FIG. 2A is a block diagram of an example cloud-based server 200, including a content event detection unit 206 to determine and transmit a content event corresponding to a scene displayed on an electronic device 208. As used herein, cloud-based server 200 may include any hardware, programming, service, and/or other resource that is available to a user through a cloud. If neural networks to determine the content event is implemented in the cloud, electronic device 208 (e.g., the gaming device) runs an agent 212 that sends the captured video and audio content to cloud-based server 200. When the video and audio content is received, cloud-based server 200 may perform pre-processing of video and audio content and neural network calculations, and send the output of the neural networks (e.g., a types of game scene, action, or content event) back to agent 212 running in electronic device 208. Agent 212 may feed the received data to alighting driver for lighting effects control.

In one example, cloud-based server 200 may include a processor 202 and a memory 204. Memory 204 may include content event detection unit 206. In some examples, content event detection unit 206 may be implemented as engines or modules comprising any combination of hardware and programming to implement the functionalities described herein.

During operation, content event detection unit 206 may receive video content and audio content from agent 212 residing in electronic device 208. The video content and audio content may be generated by an application 210 of a computer game being executed on electronic device 208.

Further, content event detection unit 206 may pre-process the video content and the audio content. Content event detection unit 206 may analyze the pre-processed video content and the pre-processed audio content to generate a plurality of synthetic feature vectors. Further, content event detection unit 206 may process the plurality of synthetic feature vectors to determine a content event corresponding to a scene displayed on a display (e.g., a touchscreen display) associated with electronic device 208. Example display may be a liquid crystal display (LCD), a light emitting diode (LED) display, an organic light emitting diode (OLED) display, a plasma display panel (PDP), an electro-luminescent (EL) display, or the like. Then, content event detection unit 206 may transmit the content event to agent 212 residing in electronic device 208 for controlling an ambient light effect in relation to the scene. An example operation to determine and transmit the content event is explained in FIG. 2B.

FIG. 28 is a block diagram of example cloud-based server 200 of FIG. 2A, depicting additional features. For example, similarly named elements of FIG. 2B may be similar in structure and/or function to elements described with respect to FIG. 2A. As shown in FIG. 2B, content event detection unit 206 may include a first pre-processing unit 252 and a second pre-processing unit 254 to receive video content and audio content, respectively, from agent 212. First pre-processing unit 252 and a second pre-processing unit 254 may pre-process the video content and the audio content, respectively.

Further, content event detection unit 206 may receive pre-processed video content from first pre-processing unit 252 and analyze the pre-processed video content using a first neural network 256 to generate a plurality of video feature vectors. Each video feature vector may correspond to a video frame of the video content. For example, first neural network 256 may include a trained convolutional neural network.

Furthermore, content event detection unit 206 may receive pre-processed audio content from second pre-processing unit 254 and analyze the pre-processed audio content using a second neural network 258 to generate a plurality of audio feature vectors. Each audio feature vector may correspond to an audio segment of the audio content. For example, second neural network 258 may include a trained speech recognition neural network.

Further, content event detection unit 206 may include an adder or merger 260 to concatenate the video feature vectors with a corresponding one of the audio feature vectors to generate the plurality of synthetic feature vectors. Content event detection unit 206 may process the plurality of synthetic feature vectors by applying a third neural network 262 to determine the content event. For example, third neural network 262 may include a trained recurrent neural network. Content event detection unit 206 may send the content event to agent 212 running in electronic device 208. Agent 212 may feed the received data to a controller 264 (e.g., the lighting driver) in electronic device 208. Controller 264 may select a lighting profile corresponding to the content event from a plurality of lighting profiles 266 stored in a database 268. Then, controller 264 may control lighting device 270 according to the lighting profile to render the ambient light effect in relation to the scene. Therefore, when network bandwidth and delay can meet the demand, neural networks computing can be moved to cloud-based server 200, for instance, to alleviate resource constraints.

Electronic device 100 of FIGS. 1A and 1B or cloud-based server 200 of FIGS. 2A and 2B may include computer-readable storage medium comprising (e.g., encoded with) instructions executable by a processor to implement respective functionalities described herein in relation to FIGS. 1A-2B. In some examples, the functionalities described herein, in relation to instructions to implement functions of components of electronic device 100 or cloud-based server 200 and any additional instructions described herein in relation to the storage medium, may be implemented as engines or modules comprising any combination of hardware and programming to implement the functionalities of the modules or engines described herein. The functions of components of electronic device 100 or cloud-based server 200 may also be implemented by a respective processor. In examples described herein, the processor may include, for example, one processor or multiple processors included in a single device or distributed across multiple devices.

FIG. 3 is a schematic diagram of an example neural network architecture 300, depicting a convolutional neural network 302 and a recurrent neural network 304 for determining a type of action or content event. As shown in FIG. 3, convolutional neural network 302 may provide video feature vectors (e.g., f₁, f₂, . . . fₜ) to recurrent neural network 304. Similarly, a speech recognition neural network or an audio processing algorithm may be used to provide audio feature vectors (m₁, m₂, . . . mₜ) to recurrent neural network 304. In one example, m₁, m₂, . . . mₜ may denote Mel-Frequency Cepstral Coefficient (MFCC) vectors (herein after referred to as audio feature vectors) extracted from audio segments of the audio content, and f₁, f₂, . . . fₜ may denote the video feature vectors extracted from the video frames of the video content.

When video stream is used to identify action or content event, a hybrid architecture of convolutional neural network 302 and recurrent neural network 304 can be used to determine a type of action or content event. In one example, convolutional neural network 302 and recurrent neural network 304 can be fine-tuned using game screenshots marked with the scene tag. Since the screen style and scenes of different games diverse dramatically, transfer learning may be performed separately for different games to get suitable network parameters. In this example, convolutional neural network 302 may be used for game scene recognition, such as an aircraft height, while an intermediate output of convolutional neural network 302 may be provided as input to the recurrent neural network 304 in order to determine content event or action, such as occurring of the aircraft steep descent.

Consider an example of residual neural network (ResNet). In this example, the neural network may be divided into convolutional layers 306 and fully connected layers 308. An output of a fully connected layer 308 (in the form of a vector) can be used as an input of recurrent neural network 304. Each time the convolutional neural network 302 processes one frame of the video content (i.e., spatial data), a feature vector (e.g., f₁ to fₜ) may be generated and transmitted to recurrent neural network 304. Over the time, a stream of feature vectors (e.g., f₁, f₂, and f₃) may form temporal data as the input to the recurrent neural network. Thus, convolutional neural network may output spatiotemporal feature vectors corresponding to video frames. Further, recurrent neural network 304 may process the temporal data to infer the action or content event that is currently taking place. In order to effectively capture long-term dependencies, units in recurrent neural network 304 may take gating mechanism such as Long Short-Term Memory (LSTM) and Gated Recurrent Units (GRU).

Similarly, when the audio content is used along with video content for event recognition, the input data of recurrent network is the synthesis of the video feature vector and the audio feature vector as shown in FIG. 3. In this example, each video frame may be associated with a corresponding audio segment. Then, an audio feature vector (e.g., m₁) of an audio segment may be calculated. When a video feature vector (e.g., f₁) of a video frame is generated (e.g., by the fully connected layer of the convolution neural network), video feature vector (f₁) may be concatenated with audio feature vector (m₁) of an associated audio segment to generate a synthetic vector. Over the time, a stream of synthetic vectors may form temporal data and fed to recurrent neural network 304 for determining the action or content event.

In other examples, video content can be used for action or content event recognition. In this case, a convolutional neural network 302 and a recurrent network 304 can be used to analyse and process the video content for determining the action or content event. In another example, audio content can be used for action or content event recognition. In this case, a speech recognition neural network may be selected and then fine-tuned with tagged game audio segments. The fine-tuned speech recognition neural network can then be used for the action or content event recognition. However, by using both audio content and video content (i.e., visual data) in combination, the neural networks can achieve an enhanced scene, action, or content event prediction accuracy than using the visual data or audio content.

FIG. 4 is a block diagram of an example electronic device 400 including a non-transitory machine-readable storage medium 404, storing instructions to control a device to render an ambient effect in relation to a scene. Electronic device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to electronic device 400.

As shown in FIG. 4, machine-readable storage medium 404 may store instructions 406-414. In an example, instructions 406-414 may be executed by processor 402 to control the ambient effect in relation to a scene. Instructions 406 may be executed by processor 402 to capture video content and audio content that are generated by an application being executed on an electronic device.

Instructions 408 may be executed by processor 402 to analyze the video content and the audio content, using a first machine learning model, to generate a plurality of synthetic feature vectors. Example first machine learning model may include a convolutional neural network and a speech recognition neural network to process the video content and the audio content, respectively.

Machine-readable storage medium 404 may further store instructions to pre-process the video content and the audio content prior to analyzing the video content and the audio content of the application. In one example, the video content may be pre-processed to adjust a set of video frames of the video content to an aspect ratio, scale the set of video frames to a resolution, normalize the set of video frames, or any combination thereof. Further, the audio content may be pre-processed to divide the audio content into partially overlapping segments by time and convert the partially overlapping segments into a frequency domain presentation. Then, the pre-processed video content and the pre-processed audio content may be analyzed to generate the plurality of synthetic feature vectors for the set of video frames.

In one example, instructions to analyze the video content and the audio content may include instructions to associate each video frame of the video content with a corresponding audio segment of the audio content, analyze the video content using the convolutional neural network to generate a plurality of video feature vectors, each video feature vector corresponds to a video frame of the video content, analyze the audio content using the speech recognition neural network to generate a plurality of audio feature vectors, each audio feature vector corresponds to an audio segment of the audio content, and concatenate the video feature vectors with a corresponding one of the audio feature vectors to generate the plurality of synthetic feature vectors.

Instructions 410 may be executed by processor 402 to process the plurality of synthetic feature vectors, using a second machine learning model, to determine a content event corresponding to a scene displayed on the electronic device. Example second machine learning model may include a recurrent neural network.

Instructions 412 may be executed by processor 402 to select an ambient effect profile corresponding to the content event. Instructions 414 may be executed by processor 402 to control a device according to the ambient effect profile in real-time to render an ambient effect in relation to the scene. In one example instructions to control the device according to the ambient effect profile may include instructions to operate a lighting device according to the ambient effect profile to render an ambient light effect in relation to the scene displayed on the electronic device.

Even though examples described in FIGS. 1A-4 utilize neural networks for determining the content event, examples described herein can also be implemented using logic-based rules and/or heuristic techniques (e.g., fuzzy logic) to process the audio and video content for determining the content event.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a capturing unit to capture video content and audio content of an application being executed on the electronic device;
an analyzing unit to analyze the video content and the audio content to generate a plurality of synthetic feature vectors;
a processing unit to process the plurality of synthetic feature vectors to determine a content event corresponding to a scene displayed on the electronic device; and
a controller to select an ambient effect profile corresponding to the content event and control a device according to the ambient effect profile to render an ambient effect in relation to the scene.

2. The electronic device of claim 1, wherein the analyzing unit is to:
analyze the video content using a convolutional neural network to generate a plurality of video feature vectors, each video feature vector corresponds to a video frame of the video content;
analyze the audio content using a speech recognition neural network to generate a plurality of audio feature vectors, each audio feature vector corresponds to an audio segment of the audio content; and
concatenate the video feature vectors with a corresponding one of the audio feature vectors to generate the plurality of synthetic feature vectors.

3. The electronic device of claim 1, wherein the processing unit is to process the plurality of synthetic feature vectors by applying a recurrent neural network to determine the content event.

4. The electronic device of claim 1, further comprising:
a first pre-processing unit to pre-process the video content prior to analyzing the video content; and
a second pre-processing unit to pre-process the audio content prior to analyzing the audio content.

5. The electronic device of claim 1, wherein the capturing unit is to capture the video content and the audio content generated by the application of a computer game during a game play.

6. A cloud-based server comprising:
a processor; and
a memory, wherein the memory comprises a content event detection unit to:
receive video content and audio content from an agent residing in an electronic device, the video content and audio content generated by an application of a computer game being executed on the electronic device;
pre-process the video content and the audio content;
analyze the pre-processed video content and the pre-processed audio content to generate a plurality of synthetic feature vectors;
process the plurality of synthetic feature vectors to determine a content event corresponding to a scene displayed on the electronic device; and
transmit the content event to the agent residing in the electronic device for controlling an ambient light effect in relation to the scene.

7. The cloud-based server of claim 6, wherein the content event detection unit is to:
analyze the pre-processed video content using a first neural network to generate a plurality of video feature vectors, each video feature vector corresponds to a video frame of the video content;
analyze the pre-processed audio content using a second neural network to generate a plurality of audio feature vectors, each audio feature vector corresponds to an audio segment of the audio content; and
concatenate the video feature vectors with a corresponding one of the audio feature vectors to generate the plurality of synthetic feature vectors.

8. The cloud-based server of claim 7, wherein the first neural network and the second neural network comprise a trained convolutional neural network and a trained speech recognition neural network, respectively.

9. The cloud-based server of claim 6, wherein the content event detection unit is to process the plurality of synthetic feature vectors by applying a third neural network to determine the content event, wherein the third neural network is a trained recurrent neural network.

10. A non-transitory computer-readable storage medium encoded with instructions that, when executed by a processor, cause the processor to:
capture video content and audio content that are generated by an application being executed on an electronic device;
analyze the video content and the audio content, using a first machine learning model, to generate a plurality of synthetic feature vectors;
process the plurality of synthetic feature vectors, using a second machine learning model, to determine a content event corresponding to a scene displayed on the electronic device;
select an ambient effect profile corresponding to the content event; and
control a device according to the ambient effect profile in real-time to render an ambient effect in relation to the scene.

11. The non-transitory computer-readable storage medium of claim 10, wherein the first machine learning model comprises a convolutional neural network and a speech recognition neural network to process the video content and the audio content, respectively.

12. The non-transitory computer-readable storage medium of claim 11, wherein instructions to analyze the video content and the audio content comprise instructions to:
associate each video frame of the video content with a corresponding audio segment of the audio content;
analyze the video content using the convolutional neural network to generate a plurality of video feature vectors, each video feature vector corresponds to a video frame of the video content;
analyze the audio content using the speech recognition neural network to generate a plurality of audio feature vectors, each audio feature vector corresponds to an audio segment of the audio content; and
concatenate the video feature vectors with a corresponding one of the audio feature vectors to generate the plurality of synthetic feature vectors.

13. The non-transitory computer-readable storage medium of claim 10, wherein the second machine learning model comprises a recurrent neural network.

14. The non-transitory computer-readable storage medium of claim 10, wherein instructions to control the device according to the ambient effect profile comprise instructions to:
operate a lighting device according to the ambient effect profile to render an ambient light effect in relation to the scene displayed on the electronic device.

15. The non-transitory computer-readable storage medium of claim 10, wherein instructions to analyze the video content and the audio content of the application comprise instructions to:
pre-process the video content and the audio content comprising:
pre-process the video content to adjust a set of video frames of the video content to an aspect ratio, scale the set of video frames to a resolution, normalize the set of video frames, or any combination thereof; and
pre-process the audio content to divide the audio content into partially overlapping segments by time and convert the partially overlapping segments into a frequency domain presentation; and
analyze the pre-processed video content and the pre-processed audio content to generate the plurality of synthetic feature vectors for the set of video frames.
